(19) United States
(12) Patent Application Publication
(10) Pub. No.: US 2024/0290534 A1
(43) Pub. Date: Aug. 29, 2024

(54) ULTRA-SLIM MAGNETIC COUPLING DEVICE

(71) Applicant: LG INNOTEK CO., LTD., Seoul (KR)

(72) Inventors: Jae Han SUH, Seoul (KR); In Seong SOHN, Seoul (KR); Seok BAE, Seoul (KR)

(21) Appl. No.: 18/573,714

(22) PCT Filed: Jun. 29, 2022
(86) PCT No.: PCT/KR2022/009277

§ 371 Date: Dec. 22, 2023

(30) Foreign Application Priority Data
Jun. 29, 2021 (KR) 10-2021-0084735

(51) Int. Cl. H01F 27/28; H01F 27/24

(52) U.S. Cl. CPC H01F 27/2823; H01F 27/24; H01F 27/2804

(57) ABSTRACT

The present invention relates to a magnetic component. The magnetic component includes, for example, an inductor, a transformer, and the like, but is not limited thereto. The magnetic component according to an embodiment of the present invention includes: a magnetic core; a second substrate disposed on one side of the core; a first substrate disposed facing the second substrate with the core interposed therebetween; and a coil including a plurality of coil patterns attached to the second substrate and the first substrate and a plurality of conductors that pass through the core and electrically connect the coil patterns of the second substrate and the first substrate.

### TECHNICAL FIELD

The present disclosure relates to a magnetic coupling device. The magnetic coupling device includes, for example, a magnetic component such as an inductor or a transformer, without being limited thereto.

### BACKGROUND ART

With the trend toward slim TVs, there is great demand for slimness of power boards used therefor.

Magnetic components such as inductors or transformers may be mounted on power boards. According to the demand for slimness of power boards, slim magnetic components are being developed.

FIG. 1 illustrates a transformer as an example of a conventional magnetic component.

The transformer shown in FIG. 1 includes a core 1, which includes an upper core 1a and a lower core 1b, and a coil unit 2 disposed within the core 1.

The coil unit 2 includes a first coil 2a and a second coil 2b. In order to achieve slimness, each of the first coil 2a and the second coil 2b is formed by plating a coil pattern on a printed circuit board. Conventionally, the coil 2 is formed by winding a copper wire. However, as shown in FIG. 1, in order to achieve slimness, the coil 2 is formed through plating on a printed circuit board (in FIG. 1, illustration of the printed circuit board is omitted, and only the coil plating pattern is illustrated for convenience).

Although a very slim magnetic component has been realized as shown in FIG. 1, there is demand for a slimmer magnetic component, a so-called ultra-slim magnetic component, as the slimness of TVs has recently accelerated. Therefore, there is a need for a magnetic component having a new structure capable of meeting requirements for ultra-slimness.

### DISCLOSURE

### Technical Problem

An object of the present disclosure is to solve at least one of the above problems with the related art.

An object of the present disclosure is to provide a magnetic component having a new structure capable of meeting requirements for ultra-slimness.

### Technical Solution

A magnetic coupling device according to an embodiment of the present disclosure includes a first substrate, a magnetic core unit disposed on the first substrate, a second substrate disposed on the magnetic core unit, and a conductive wire unit conductively connecting the first substrate to the second substrate. The magnetic core unit includes a first core and a second core spaced apart from each other in a horizontal direction, and the conductive wire unit extends from the first substrate toward the second substrate and is disposed between the first core and the second core.

In at least one embodiment of the present disclosure, a width of at least one side of the core unit is greater than a width of a corresponding side of the first substrate or the second substrate.

In addition, in at least one embodiment of the present disclosure, each of the first substrate and the second substrate includes a plurality of through-holes facing each other.

In at least one embodiment of the present disclosure, the conductive wire unit interconnects the through-holes in the first substrate and the through-holes in the second substrate.

In addition, in at least one embodiment of the present disclosure, the conductive wire unit interconnects the first substrate and the second substrate in the form of a plurality of closed loops.

In at least one embodiment of the present disclosure, each of the first substrate and the second substrate includes a plurality of coil patterns plated thereon.

Here, the plurality of coil patterns may include a plurality of 1-1^{st} coil patterns and a plurality of 1-2^{nd} coil patterns plated on the first substrate and a plurality of 2-1^{st} coil patterns and a plurality of 2-2^{nd} coil patterns plated on the second substrate, the conductive wire unit may include a plurality of first conductors conductively interconnecting the 1-1^{st} coil patterns and the 2-1^{st} coil patterns and a plurality of second conductors conductively interconnecting the 1-2^{nd} coil patterns and the 2-2^{nd} coil patterns, and the coil may include a first coil including the 1-1^{st} coil patterns, the 2-1^{st} coil patterns, and the first conductors and a second coil including the 1-2^{nd} coil patterns, the 2-2^{nd} coil patterns, and the second conductors.

In addition, in at least one embodiment of the present disclosure, the second coil is disposed so as to surround the first coil, the 1-1^{st} coil patterns and the 1-2^{nd} coil patterns are disposed on different layers on the first substrate, and the 2-1^{st} coil patterns and the 2-2^{nd} coil patterns are disposed on different layers on the second substrate.

In at least one embodiment of the present disclosure, the conductive wire unit is connected to the first substrate and the second substrate through soldering.

Here, the conductive wire unit may be soldered to a surface of each of the substrates formed opposite the core.

In addition, in at least one embodiment of the present disclosure, the conductive wire unit includes pins.

In at least one embodiment of the present disclosure, each of the pins includes both ends at least partially inserted into the first substrate and the second substrate.

In at least one embodiment of the present disclosure, the core includes at least one E-shaped core including a pair of outer legs and a center leg.

In addition, here, the E-shaped core may have an E-shaped cross-section in a direction perpendicular to the substrates.

In addition, in at least one embodiment of the present disclosure, the core is fixed so as to be restricted in movement between the substrates.

Here, the core and the substrates may be wrapped by a sheet of tape in the state in which the core is inserted between the substrates.

In addition, in at least one embodiment of the present disclosure, the periphery of the conductive wire unit is molded with a resin.

In at least one embodiment of the present disclosure, a bobbin surrounding the periphery of the conductive wire unit is additionally mounted.

### Advantageous Effects

According to the present disclosure, a magnetic component having a slimmer structure than the conventional art may be obtained.

In addition, when achieving slimness while maintaining the conventional structure, there occur problems in that an allowable window area for coil windings is reduced and there is a limitation on reduction in the cross-sectional area of the wire due to allowable current. However, the present disclosure may achieve ultra-slimness without the occurrence of the above problems.

### DESCRIPTION OF DRAWINGS

FIG. 1 illustrates a conventional magnetic component.

FIG. 2 illustrates a first embodiment (inductor) of the present disclosure.

FIG. 3 is an exploded perspective view of the magnetic component shown in FIG. 2.

FIG. 4 is a top view of the magnetic component shown in FIG. 2.

FIG. 5 illustrates a second embodiment (transformer) of the present disclosure.

FIG. 6 is a rear view of the magnetic component shown in FIG. 5.

FIG. 7 is a side view of the magnetic component shown in FIG. 5.

FIGS. 8 (a) and (b) illustrates comparison in thickness between the conventional magnetic component and the magnetic component according to the present disclosure.

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

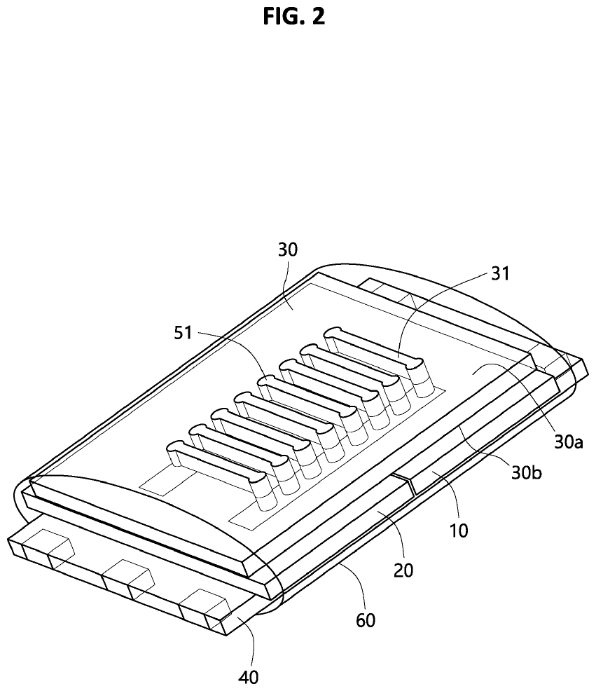

An inductor according to a first embodiment of the present disclosure will be described with reference to FIGS. 2 to 4.

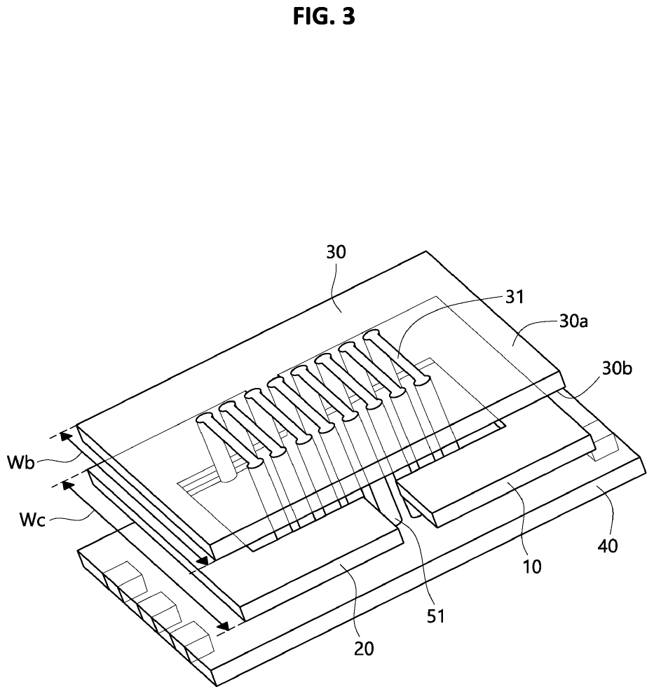

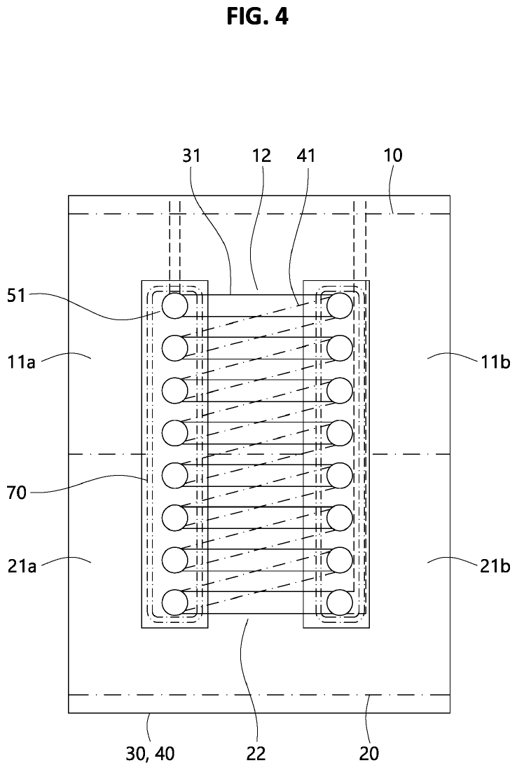

First, FIG. 2 is a conceptual perspective view of the inductor, FIG. 3 is an exploded perspective view of the inductor in FIG. 2, and FIG. 4 is a top view of the inductor in FIG. 2.

The inductor in FIG. 2 includes a first substrate 40 and a second substrate 30, and a core unit is disposed between the first substrate 40 and the second substrate 30. The core unit is disposed on the first substrate 40, and the second substrate 30 is disposed on the core unit.

In this embodiment, the width Wc of one side of the core unit is equal to or greater than the width Wb of a corresponding side of the first substrate 40 or the second substrate 30.

The core unit includes a first core 10 and a second core 20, which are disposed between the first substrate 40 and the second substrate 30 so as to face each other horizontally.

As shown in FIG. 4, the first core 10 includes a pair of first outer legs 11a and 11b and a first center leg 12, and the second core 20 also includes a pair of second outer legs 21a and 21b and a second center leg 22 (in FIG. 4, the cores are indicated by an alternate long and short dash line, and a second coil pattern is indicated by a dotted line).

In this embodiment, each of the first core 10 and the second core 20 corresponds to an E-shaped core in plan view (when viewed in a direction perpendicular to the substrate). However, the disclosure is not limited thereto.

The first substrate 40 is disposed so as to cover one side of each of the first core 10 and the second core 20, and the second substrate 30 is disposed opposite the first substrate 40, with the first core 10 and the second core 20 interposed therebetween.

A first coil pattern 41 is plated on the first substrate 40, and a second coil pattern 31 is plated on the second substrate 30.

The second coil pattern 31 is formed on an opposite surface 30a of the second substrate 30, rather than on a surface 30b of the second substrate 30 that faces the cores 10 and 20. Similarly, the first coil pattern 41 is formed on the surface of the first substrate 40 that is opposite the cores 10 and 20. Since the coil patterns are formed on the opposite surfaces of the substrates, rather than on the surfaces of the substrates that face the cores 10 and 20, it is easy to solder conductors 51, which will be described later, to the coil patterns.

The first coil pattern 41 and the second coil pattern 31 are conductively connected to each other via a plurality of conductors 51 disposed so as to pass through spaces defined between the outer legs 11a, 11b, 21a, and 21b and the center legs 12 and 22 of the cores 10 and 20. That is, in each of the first substrate 40 and the second substrate 30, a pair of through-holes is formed at positions corresponding to the spaces between the outer legs 11a, 11b, 21a, and 21b and the center legs 12 and 22 so as to be spaced apart from each other by a distance substantially equal to or greater than the width of the outer legs 11a, 11b, 21a, and 21b. In the structure in which the through-holes in the first substrate 40 and the second substrate 30 are disposed opposite each other with the core unit interposed therebetween, the first and second coil patterns are conductively connected to each other via the plurality of conductors 51.

As shown in FIG. 4, the conductors 51 are disposed laterally with the center legs 12 and 22 interposed between, and are conductively connected to each other via the first coil pattern 41 and the second coil pattern 31.

In this embodiment, the first coil pattern 41 is formed to interconnect the conductors 51 in an oblique direction, and the second coil pattern 31 is formed to interconnect the conductors 51 in a horizontal direction. However, the coil patterns are not limited thereto.

The first coil pattern 41, the conductors 51, and the second coil pattern 31 are physically connected to form a plurality of closed-loop coil turns and to spirally surround the center legs 12 and 22, thereby constituting a single coil in the magnetic component.

In this embodiment, the conductors 51 are conductive metal pins that penetrate the first substrate 40 and the second substrate 30 such that end portions thereof are exposed to the coil patterns 31 and 41 and are conductively connected to the coil patterns 31 and 41 through soldering.

The conductors 51 are not limited to pins, and copper wires such as Litz wires may be used.

In addition, in this embodiment, the first substrate 40 and the second substrate 30 are implemented as printed circuit boards, and the first coil pattern 41 and the second coil pattern 31 are implemented as plating patterns plated thereon. However, the disclosure is not necessarily limited thereto. The substrates may be simple plate-shaped insulators, rather than being printed circuit boards, and the coil patterns may be formed in such a manner that copper plates or rectangular copper wires are attached to and supported by the substrates.

Meanwhile, in the state in which the first and second substrates 40 and 30 and the cores 10 and 20 disposed therebetween are assembled, these components may be wrapped by a sheet of tape 60, as shown in FIG. 2, so that the components are fixed and protected from the outside.

In addition, as shown in FIG. 4, bobbins 71 may be further provided to surround the conductors 51 disposed between the outer legs 11a, 11b, 21a, and 21b and the center legs 12 and 22. Here, spaces not occupied by the bobbins 70 may undergo resin molding.

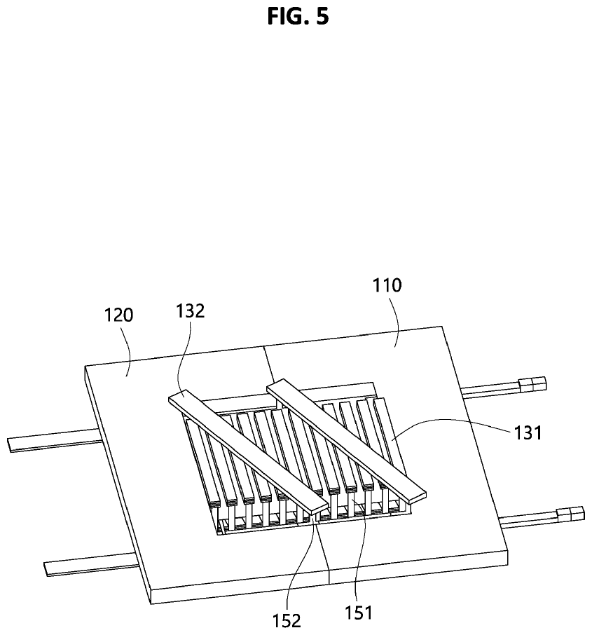

Hereinafter, a transformer as a second embodiment of the present disclosure will be described with reference to FIGS. 5 to 7.

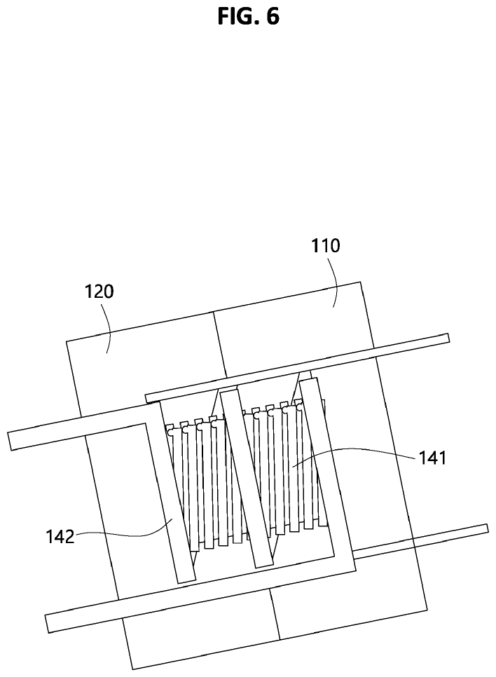

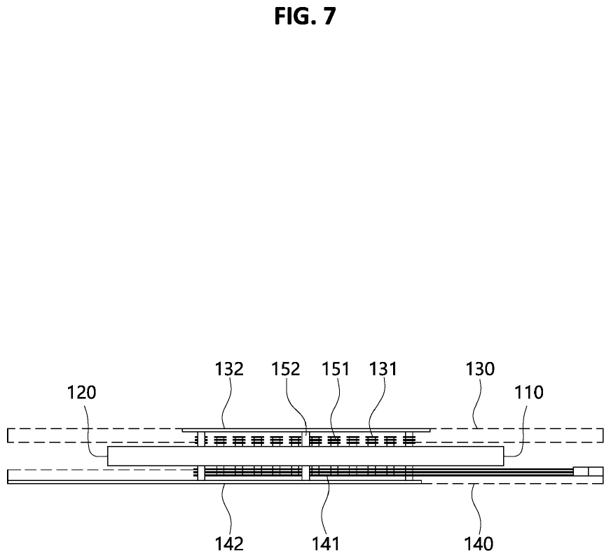

First, FIG. 5 is a perspective view of the transformer, FIG. 6 is a rear view thereof, and FIG. 7 is a side view thereof.

In FIGS. 5 and 6, for convenience, illustration of substrates is omitted, and only coil patterns are illustrated. In FIG. 7, substrates 130 and 140 are conceptually illustrated using dotted lines.

In the transformer of this embodiment, a first core 110 and a second core 120 are also E-shaped cores, and are disposed horizontally so as to face each other. The first and second cores 110 and 120 of this embodiment are structurally the same as the cores 10 and 20 of the first embodiment.

The first substrate 140 and the second substrate 130 of this embodiment are also printed circuit boards. A 1-1^{st} coil pattern 141 and a 1-2^{nd} coil pattern 142 are plated on the first substrate 140, and a 2-1^{st} coil pattern 131 and a 2-2^{nd} coil pattern 132 are plated on the second substrate 130.

Here, the 1-1^{st} coil pattern 141 and the 1-2^{nd} coil pattern 142 are disposed on different layers on the first substrate 140 in an isolated manner in order to avoid interference therebetween, and the 2-1^{st} coil pattern 131 and the 2-2^{nd} coil pattern 132 are also disposed on different layers on the second substrate 130 in an isolated manner. That is, in this embodiment, each of the substrates 130 and 140 is a printed circuit board including six layers. As shown in FIG. 7, three upper layers of the first substrate 140 include the 1-1^{st} coil pattern 141, and two lower layers thereof include the 1-2^{nd} coil pattern 142. Three lower layers of the second substrate 130 include the 2-1^{st} coil pattern 131, and two upper layers thereof include the 2-2^{nd} coil pattern 132.

Based on the first core 110 and the second core 120, the 1-1^{st} coil pattern 141 and the 2-1^{st} coil pattern 131 are formed on the inner layers, and the 1-2^{nd} coil pattern 142 and the 2-2^{nd} coil pattern 132 are formed on the outer layers.

Meanwhile, the conductors include a plurality of first conductors 151 interconnecting the 1-1^{st} coil pattern 141 and the 2-1^{st} coil pattern 131 and a plurality of second conductors 152 interconnecting the 1-2^{nd} coil pattern 142 and the 2-2^{nd} coil pattern 132.

In plan view, a pair of left and right first conductors 151 is disposed on the inner side, and a pair of left and right second conductors 152 is disposed on the outer side so as to surround the first conductors 151.

In this embodiment, the 1-1^{st} coil pattern 141, the 2-1^{st} coil pattern 131, and the first conductors 151 constitute a first coil (primary coil), and the 1-2^{nd} coil pattern 142, the 2-2^{nd} coil pattern 132, and the second conductors 152 constitute a second coil (secondary coil).

Meanwhile, similar to the first embodiment, a sheet of tape 60, a bobbin 70, or resin molding may also be applied to this embodiment.

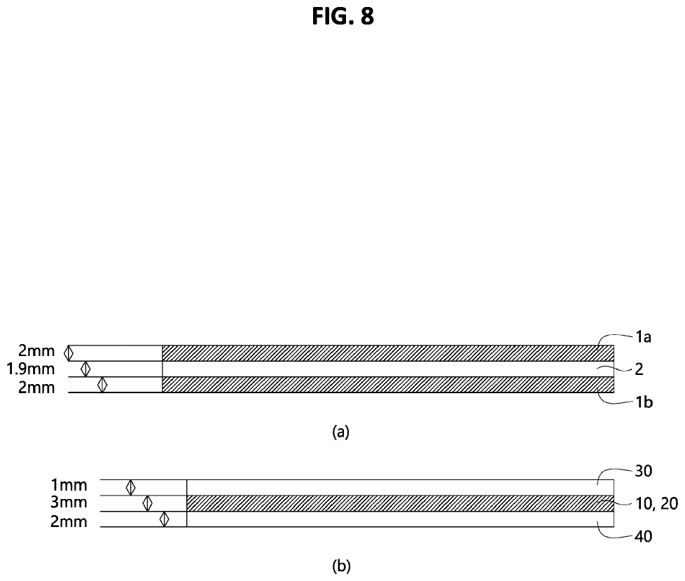

The magnetic components of the above-described embodiments may achieve an ultra-slim structure compared to the conventional magnetic component, and comparison in the structure therebetween is shown in FIG. 8.

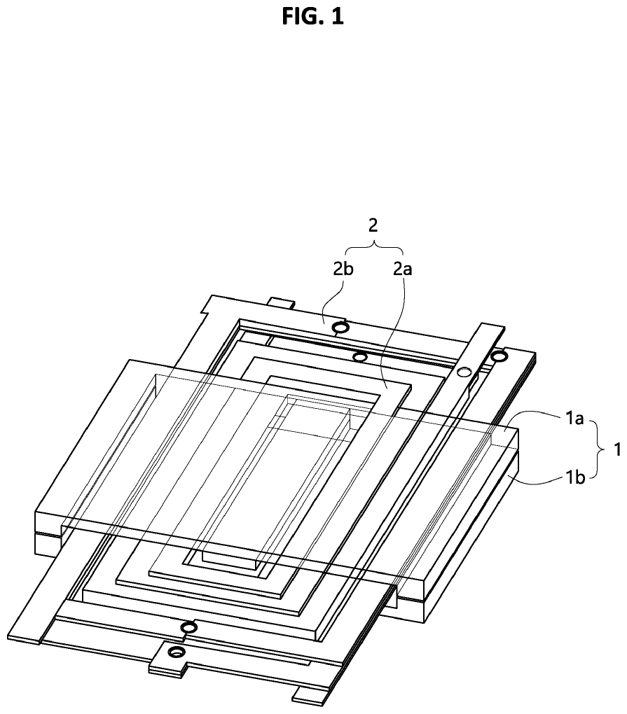

FIG. 8(a) illustrates the thickness of the magnetic component structure shown in FIG. 1, and FIG. 8(b) illustrates the thickness of the magnetic component structure of the embodiment shown in FIG. 2.

In the case of (a), the thickness of each of the upper core 1a and the lower core 1b disposed on both outer sides is 2 mm, and the thickness of the printed circuit board 2 (coil unit in FIG. 1) disposed therebetween is 1.9 mm (six-layered structure). That is, the conventional structure has a total thickness of 5.9 mm. In contrast, in the case of (b), the thickness of each of the substrates 30 and 40 disposed on both outer sides is 1 mm, and the thickness of the core 10 or 20 disposed therebetween may be up to 3 mm, whereby the total thickness becomes 5 mm.

When the height of the product is limited to 6 mm, because the printed circuit board of the conventional product includes six layers of 1.9 mm, the thickness of each of the core plates 1a and 1b is limited to 2 mm or less. However, in the embodiment of the present disclosure, the core may be manufactured up to 3 mm.

In addition, compared to the conventional structure, the embodiment of the present disclosure has an advantage in that the mounting area required for each printed circuit board is reduced.

### INDUSTRIAL APPLICABILITY

An ultra-slim magnetic coupling device according to the above-described embodiment may be used for power supply devices of various electronic products.

1. A magnetic coupling device comprising:
a first substrate;
a magnetic core unit disposed on the first substrate;
a second substrate disposed on the magnetic core unit; and
a conductive wire unit conductively connecting the first substrate to the second substrate,
wherein the magnetic core unit comprises a first core and a second core spaced apart from each other in a horizontal direction, and
wherein the conductive wire unit extends from the first substrate toward the second substrate and is disposed between the first core and the second core.

2. The magnetic coupling device according to claim 1, wherein a width of at least one side of the core unit is greater than a width of a corresponding side of the first substrate or the second substrate.

3. The magnetic coupling device according to claim 1, wherein each of the first substrate and the second substrate comprises a plurality of through-holes facing each other.

4. The magnetic coupling device according to claim 3, wherein the conductive wire unit interconnects the through-holes in the first substrate and the through-holes in the second substrate.

5. The magnetic coupling device according to claim 1, wherein the conductive wire unit interconnects the first substrate and the second substrate in a form of a plurality of closed loops.

6. The magnetic coupling device according to claim 1, wherein each of the first substrate and the second substrate comprises a plurality of coil patterns plated thereon.

7. The magnetic coupling device according to claim 6, wherein the plurality of coil patterns comprises a plurality of 1-1^{st} coil patterns and a plurality of 1-2^{nd} coil patterns plated on the first substrate and a plurality of 2-1^{st} coil patterns and a plurality of 2-2^{nd} coil patterns plated on the second substrate,
wherein the conductive wire unit comprises a plurality of first conductors conductively interconnecting the 1-1^{st} coil patterns and the 2-1^{st} coil patterns and a plurality of second conductors conductively interconnecting the 1-2^{nd} coil patterns and the 2-2^{nd} coil patterns,
wherein a coil unit comprises a first coil and a second coil,
wherein the first coil comprises the 1-1^{st} coil patterns, the 2-1^{st} coil patterns, and the first conductors and
wherein the second coil comprises the 1-2^{nd} coil patterns, the 2-2^{nd} coil patterns, and the second conductors.

8. The magnetic coupling device according to claim 7, wherein the second coil is disposed so as to surround the first coil,
wherein the 1-1^{st} coil patterns and the 1-2^{nd} coil patterns are disposed on different layers on the first substrate, and
wherein the 2-1^{st} coil patterns and the 2-2^{nd} coil patterns are disposed on different layers on the second substrate.

9. The magnetic coupling device according to claim 1, wherein the conductive wire unit is connected to the first substrate and the second substrate through soldering.

10. The magnetic coupling device according to claim 9, wherein the conductive wire unit is soldered to a surface of each of the substrates formed opposite the core.

11. The magnetic coupling device according to claim 1, wherein the conductive wire unit comprises pins.

12. The magnetic coupling device according to claim 11, wherein each of the pins comprises both ends at least partially inserted into the first substrate and the second substrate.

13. The magnetic coupling device according to claim 1, wherein the core comprises at least one E-shaped core comprising a pair of outer legs and a center leg.

14. The magnetic coupling device according to claim 13, wherein the E-shaped core has an E-shaped cross-section in a direction perpendicular to the first substrate and the second substrate.

15. The magnetic coupling device according to claim 1, wherein the core is fixed so as to be restricted in movement between the substrates.

16. The magnetic coupling device according to claim 15, wherein the core and the substrates are wrapped by a sheet of tape in a state in which the core is inserted between the substrates.

17. The magnetic coupling device according to claim 1, wherein a periphery of the conductive wire unit is molded with a resin.

18. The magnetic coupling device according to claim 1, further comprising a bobbin surrounding the periphery of the conductive wire unit.
